(19) United States
(12) Patent Application Publication
(10) Pub. No.: US 2013/0306033 A1
(43) Pub. Date: Nov. 21, 2013

(54) RELIEF VALVE FOR HIGH-PRESSURE FUEL PUMP

(71) Applicants: NIPPON SOKEN, INC., Nishio-city (JP); DENSO CORPORATION, Kariya-city (JP)

(72) Inventors: Takehiko Kato, Nukata-gun (JP); Yutaka Miyamoto, Takahama-city (JP); Toyoji Nishiwaki, Anjo-city (JP); Shigeto Tsuge, Okazaki-city (JP); Tatsumi Oguri, Okazaki-city (JP); Koichi Ohata, Kariya-city (JP)

(73) Assignees: NIPPON SOKEN, INC., Nishio-city (JP); DENSO CORPORATION, Kariya-city (JP)

(21) Appl. No.: 13/896,867

(22) Filed: May 17, 2013

(30) Foreign Application Priority Data
May 17, 2012 (JP) 2012-113713

(51) Int. Cl. F02M 63/00; F16K 15/04

(52) U.S. Cl. CPC F02M 63/005; F16K 15/044
USPC 123/472; 137/540

(57) ABSTRACT

A relief valve includes a valving element, a movable holder, a housing having a guide hole and a valve seat, and a resilient member. The valving element is lifted from its seated state, in which the valving element is engaged with the valve seat, toward a pressurizing chamber in a lift period. The lift period includes a lift first period and a lift second period. An amount of the lift of the valving element reaches a set distance in the lift first period. The lift second period is after the amount of the lift of the valving element has reached the set distance. The movable holder slides inside the guide hole both in the lift first period and in the lift second period. A minimum clearance area between the movable holder and the guide hole is larger in the lift second period than in the lift first period.

### CROSS REFERENCE TO RELATED APPLICATION

This application is based on Japanese Patent Application No. 2012-113713 filed on May 17, 2012, the disclosure of which is incorporated herein by reference.

### TECHNICAL FIELD

The present disclosure relates to a relief valve provided between a pressurizing chamber and a high-pressure fuel passage, in a high-pressure fuel pump that pressurizes fuel drawn into the pressurizing chamber to discharge the fuel into the high-pressure fuel passage.

### BACKGROUND

Conventionally, for a relief valve of a high-pressure fuel pump, there is known a valve that releases pressure of a high-pressure fuel passage into a pressurizing chamber when the pressure in the high-pressure fuel passage becomes higher than a pressure in the pressurizing chamber by a set pressure difference or larger. Due to abnormity in, for example, a fuel injection system provided on a downstream side of the high-pressure fuel passage, the fuel discharged from the pressurizing chamber into the high-pressure fuel passage is not consumed so that the pressure of the high-pressure fuel passage exceeds its withstanding pressure value. Such a relief valve can obviate this situation.

In a valve described in Japanese Patent No. 4488486 as a relief valve of a high-pressure fuel pump, a valving element, which is engaged with or disengaged from a valve seat of a housing as a result of its reciprocation movement between a pressurizing chamber and a high-pressure fuel passage, is held in an integrally movable manner by a movable holder guided by a guide hole of the housing. Accordingly, a displacement of the valving element both toward the pressurizing chamber and toward the high-pressure fuel passage is stabilized. Thus, a relief function of the relief valve with a set pressure difference as a boundary value can be reliably fulfilled.

In the above relief valve described in Japanese Patent No. 4488486, the valving element, to which restoring force toward the high-pressure fuel passage is applied through the movable holder by a resilient member, is lifted toward the pressurizing chamber from its seated state on the valve seat against the restoring force. Therefore, because of the increase in a clearance area between the movable holder and the guide hole, the lift of the valving element is continued until a pressure difference between the high-pressure fuel passage side and the pressurizing chamber side becomes small.

However, in the case of the relief valve described in Japanese Patent No. 4488486, the clearance area between the movable holder and the guide hole does not change until the movable holder is removed from the guide hole, and increases after this removal. For this reason, when the valving element, to which the restoring force of the resilient member is applied, returns toward the high-pressure fuel passage after its lift, there may be caused such an operation failure that the movable holder which has been removed from the guide hole is inclined and thereby cannot enter into the guide hole.

### SUMMARY

The present disclosure addresses at least one of the above issues.

According to the present disclosure, there is provided a relief valve adapted for a high-pressure fuel pump that includes a pressurizing chamber and a high-pressure fuel passage and that pressurizes fuel drawn into the pressurizing chamber to discharge fuel into the high-pressure fuel passage. The relief valve is disposed between the pressurizing chamber and the high-pressure fuel passage and is configured to release pressure in the high-pressure fuel passage into the pressurizing chamber when the pressure in the high-pressure fuel passage becomes higher than pressure in the pressurizing chamber by a set pressure difference or larger. The relief valve includes a valving element, a movable holder, a housing, and a resilient member. The valving element is reciprocatable between the pressurizing chamber and the high-pressure fuel passage. The movable holder is disposed on the pressurizing chamber-side of the valving element and holds the valving element. The movable holder is movable integrally with the valving element. The housing includes a guide hole and a valve seat. The guide hole accommodates the movable holder therein and guides the movable holder toward the pressurizing chamber or toward the high-pressure fuel passage. The valving element is engaged or disengaged respectively with or from the valve seat on the high-pressure fuel passage-side. The resilient member is configured to generate restoring force to urge the movable holder toward the high-pressure fuel passage. The valving element is lifted from its seated state, in which the valving element is engaged with the valve seat, toward the pressurizing chamber in a lift period. The lift period includes a lift first period and a lift second period. An amount of the lift of the valving element reaches a set distance in the lift first period. The lift second period is after the amount of the lift of the valving element has reached the set distance. The movable holder slides inside the guide hole both in the lift first period and in the lift second period. A minimum clearance area between the movable holder and the guide hole is larger in the lift second period than in the lift first period.

According to the present disclosure, there is also provided a fuel supply system including the high-pressure fuel pump and a fuel injection system. The high-pressure fuel pump includes the relief valve. The fuel injection system is configured to inject fuel, which is supplied through the high-pressure fuel passage of the high-pressure fuel pump, into an internal combustion engine.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating a configuration of a fuel supply system in accordance with a first embodiment;

FIG. 2 is a diagram illustrating a configuration of a high-pressure fuel pump according to the first embodiment;

FIG. 3 is a characteristic diagram illustrating operation of a relief valve according to the first embodiment;

FIG. 4 is a longitudinal sectional view illustrating a main feature of the relief valve of the first embodiment;

FIG. 5 is a cross-sectional view taken along a line V-V in FIG. 4;

FIG. 6 is a longitudinal sectional view illustrating an operating state of the relief valve different from FIG. 4 according to the first embodiment;

FIG. 7 is a cross-sectional view taken along a line VII-VII in FIG. 6;

FIG. 8 is a longitudinal sectional view illustrating a modification to a movable holder in FIG. 4;

FIG. 9 is a diagram viewed from arrows IX-IX in FIG. 8;

FIG. 10 is a longitudinal sectional view illustrating a modification to the movable holder in FIG. 4;

FIG. 11 is a diagram viewed from arrows XI-XI in FIG. 10;

FIG. 12 is a longitudinal sectional view illustrating a modification to the movable holder in FIG. 4;

FIG. 13 is a cross-sectional view taken along a line XIII-XIII in FIG. 12;

FIG. 14 is a characteristic diagram illustrating the operation of the relief valve of the first embodiment;

FIG. 15 is a longitudinal sectional view illustrating a main feature of a relief valve in accordance with a second embodiment;

FIG. 16 is a cross-sectional view taken along a line XVI-XVI in FIG. 15;

FIG. 17 is a longitudinal sectional view illustrating an operating state of the relief valve different from FIG. 15;

FIG. 18 is a cross-sectional view taken along a line XVIII-XVIII in FIG. 17;

FIG. 19 is a characteristic diagram illustrating operation of the relief valve according to the second embodiment; and

FIG. 20 is a longitudinal sectional view illustrating a main feature of a sixth modification in which the first and second embodiments are combined.

### DETAILED DESCRIPTION

Embodiments will be described below in reference to the drawings. Using the same reference numeral for corresponding components throughout the embodiments, a repeated description may be omitted. In a case of description of only a part of configuration in each embodiment, a configuration in another embodiment explained ahead of the embodiment can be applied to the other part of the configuration. In addition to a combination of the configurations indicated in the descriptions of the embodiments, the configurations in the embodiments can be partially combined together even without explanation thereof as long as this combination functions.

### First Embodiment

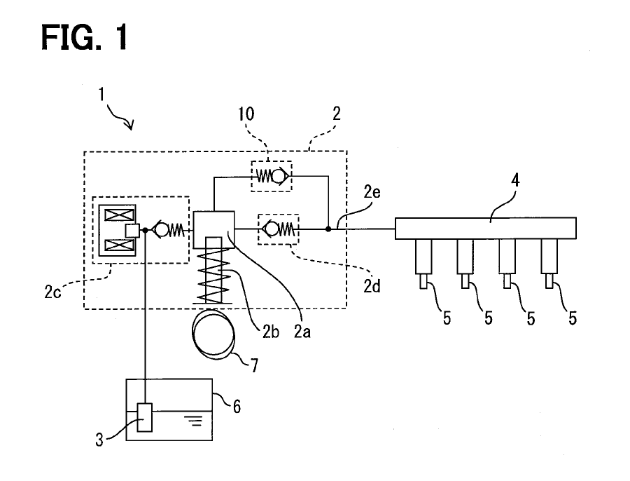

As illustrated in FIG. 1, a fuel supply system 1 including a relief valve 10 in accordance with a first embodiment is of a “direct-injection type” which injects fuel (e.g., gasoline fuel) directly into a cylinder of an internal combustion engine. The fuel supply system 1 includes a low-pressure fuel pump 3, a fuel rail 4, and a fuel injection valve 5 in addition to a high-pressure fuel pump 2 having the relief valve 10.

The low-pressure fuel pump 3 is an electric pump disposed in a fuel tank 6, and pumps up the fuel in the fuel tank 6 to supply the fuel to the high-pressure fuel pump 2. The fuel rail 4 accumulates the fuel having high pressure (e.g., 20 MPa) which is supplied through a high-pressure fuel passage 2e (described in greater detail hereinafter) of the high-pressure fuel pump 2. The fuel injection valves 5 are attached to the fuel rail 4. Each fuel injection valve 5 injects the high-pressure fuel accumulated in the fuel rail 4 into its corresponding cylinder in a timely manner.

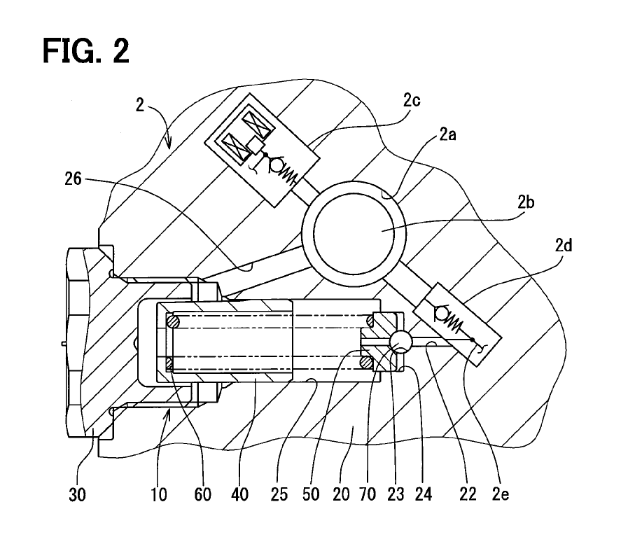

As illustrated in FIGS. 1 and 2, the high-pressure fuel pump 2 includes a pressurizing chamber 2a, a plunger 2b, a suction valve 2c, a discharge check valve 2d, the high-pressure fuel passage 2e, and the relief valve 10. Fuel having low-pressure (e.g., 400 kPa) is supplied into the pressurizing chamber 2a by the low-pressure fuel pump 3. The plunger 2b is driven in upper and lower directions by a cam 7 of the engine to realize the suction of fuel into the pressurizing chamber 2a and the pressurization of fuel in the pressurizing chamber 2a. The suction valve 2c constituted of an electromagnetic valve is opened at the time of descent of the plunger 2b when the fuel is drawn into the pressurizing chamber 2a; and on the other hand, is closed at the time of ascent of the plunger 2b when the fuel is pressurized in the pressurizing chamber 2a. When a fuel pressure in the pressurizing chamber 2a reaches a predetermined pressure or higher as a result of the fuel pressurization, the discharge check valve 2d is opened to discharge the high-pressure fuel into the high-pressure fuel passage 2e.

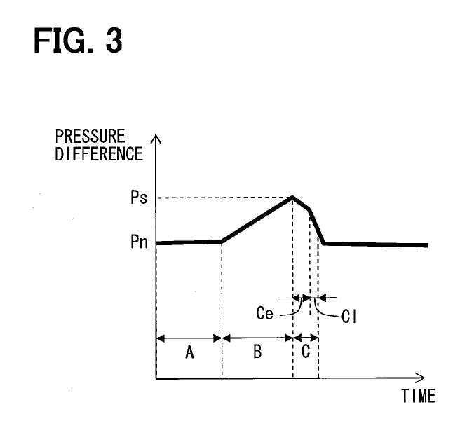

The relief valve 10 is provided between the pressurizing chamber 2a and the high-pressure fuel passage 2e. When the fuel pressure in the high-pressure fuel passage 2e becomes higher than the fuel pressure in the pressurizing chamber 2a by a set pressure difference Ps in FIG. 3 (e.g., 26 MPa) or larger, the relief valve 10 is opened to release the fuel pressure of the high-pressure fuel passage 2e into the pressurizing chamber 2a. By such a relief function, even if there should be an abnormality in the elements 4, 5 of the fuel injection system provided on a downstream side of the high-pressure fuel passage 2e as in FIG. 1, such a situation that the pressure of the high-pressure fuel passage 2e exceeds its withstanding pressure value to cause damage to the fuel supply system 1 can be obviated.

Configuration of the relief valve 10 of the first embodiment will be described in detail.

As illustrated in FIG. 2, the relief valve 10 includes a housing 20, a screw cover 30, a stopper 40, a movable holder 50, a resilient member 60 and a valving element 70.

As a housing for the entire high-pressure fuel pump 2, the housing 20 made of metal defines the pressurizing chamber 2a and the high-pressure fuel passage 2e, and the suction valve 2c and the discharge check valve 2d are integrated into the housing 20. Also, as a part of the relief valve 10, the housing 20 includes a high-pressure communication hole 22, a valve seat 23, a guide hole 24, a passage expanded hole 25 and a relief hole 26.

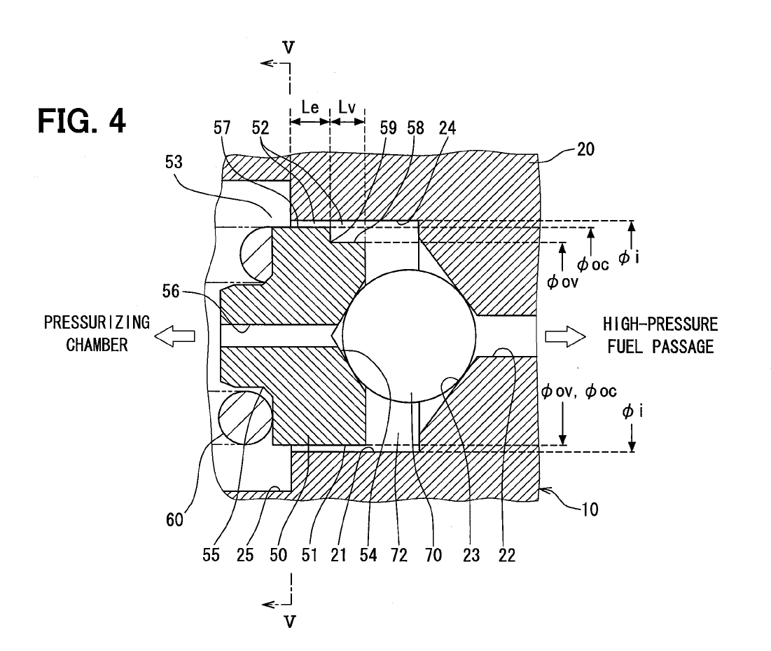

As illustrated in FIGS. 2 and 4, the high-pressure communication hole 22 has a cylindrical hole shape that branches from the high-pressure fuel passage 2e. The valve seat 23 is formed in a conical hole shape (tapered hole shape) that is coaxially connected to the high-pressure communication hole 22 on the high-pressure fuel passage 2e-side. The valve seat 23 has a diameter expanded from the high-pressure fuel passage 2e-side toward the pressurizing chamber 2a. The guide hole 24 has a cylindrical hole shape that is coaxially connected to the valve seat 23 on the high-pressure fuel passage 2e-side at a bottom part of the guide hole 24. An opening of the guide hole 24 is directed toward the pressurizing chamber 2a. The passage expanded hole 25 is formed into a cylindrical hole shape that is coaxially connected to the guide hole 24 on the high-pressure fuel passage 2e-side. The passage expanded hole 25 is formed to have a larger diameter than the opening of the guide hole 24. As illustrated in FIG. 2, an end portion of the passage expanded hole 25 on the pressurizing chamber 2a-side that communicates with the pressurizing chamber 2a through the relief hole 26 is blocked with the screw cover 30 which is screwed to the housing 20. The stopper 40 made of metal having a cylindrical shape with a bottom portion is fitted and fixed in the passage expanded hole 25 on the high-pressure fuel passage 2e-side of the screw cover 30 with an opening of the stopper 40 directed toward the high-pressure fuel passage 2e.

The movable holder 50 made of metal having a cylindrical shape is accommodated coaxially inside the guide hole 24 and the passage expanded hole 25 as illustrated in FIG. 4. An outer peripheral portion 51 of the movable holder 50 slidably reciprocates along the inside of the guide hole 24 with a fitting clearance 52 between the housing 20 and the portion 51 in a radial direction of the movable holder 50. Accordingly, the outer peripheral portion 51 is guided toward the high-pressure fuel passage 2e or toward the pressurizing chamber 2a. Also, the outer peripheral portion 51 of the movable holder 50 radially defines a loose insertion clearance 53, which is much larger than the clearance 52 between the portion 51 and the guide hole 24, in the passage expanded hole 25.

One end part of the movable holder 50 includes a holding recessed part 54 having a conical hole shape (tapered hole shape) whose diameter expanded toward the high-pressure fuel passage 2e, coaxially with the outer peripheral portion 51. The other end part of the movable holder 50 includes a receiving part 55 having a stepped cylindrical shape whose diameter reduced toward the pressurizing chamber 2a, coaxially with the outer peripheral portion 51. At a radially central part of the movable holder 50, a pressure regulation hole 56 that passes through the holder 50 between the holding recessed part 54 and the receiving part 55 is formed coaxially with the outer peripheral portion 51.

The resilient member 60 made of metal is a compression coil spring in the present embodiment, and is accommodated coaxially in the passage expanded hole 25. As illustrated in FIGS. 2 and 4, both ends of the resilient member 60 are fitted respectively in the receiving part 55 of the movable holder 50 and in the bottom portion of the stopper 40. As a result of such a configuration, the resilient member 60 is compressed between the movable holder 50 and the stopper 40, so that restoring force is generated to urge the movable holder 50 toward the high-pressure fuel passage 2e.

The valving element 70 made of metal having a full-spherical shape is accommodated in the guide hole 24 between the movable holder 50 on the pressurizing chamber 2a-side and the valve seat 23 on the high-pressure fuel passage 2e-side. The valving element 70, to which the fuel pressure in the high-pressure fuel passage 2e is applied through the high-pressure communication hole 22, is coaxially pressed on the holding recessed part 54 of the movable holder 50, to which the restoring force of the resilient member 60 is applied. Accordingly, the element 70 is held by the movable holder 50 in an integrally movable manner. In such a holding form, the valving element 70 reciprocates between the pressurizing chamber 2a and the high-pressure fuel passage 2e to be engaged with or disengaged from the valve seat 23.

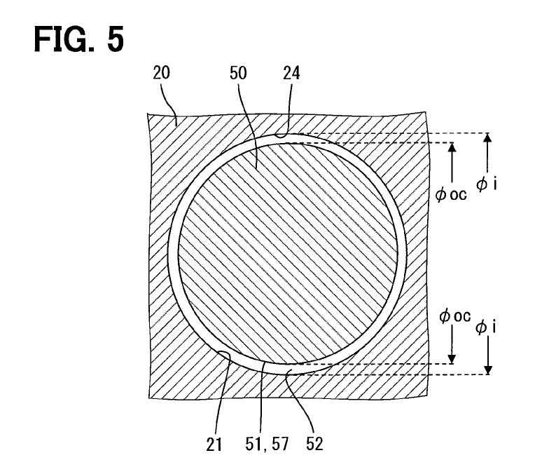

FIGS. 4 and 5 illustrate the valving element 70 in a seated state in which the valving element 70 is engaged with the valve seat 23 (hereinafter referred to simply as a seated state) as a result of a pressure difference between the high-pressure fuel passage 2e and the pressurizing chamber 2a being smaller than the set pressure difference Ps. In this seated state, the pressure of the high-pressure fuel passage 2e is applied radially inward of a circular contact line along which the valving element 70 is in contact with the valve seat 23. At the same time, in the seated state, the passage expanded hole 25, the inside of the pressure regulation hole 56, and a space portion between the valving element 70 and the holding recessed part 54 together with a pressure chamber 72 between the movable holder 50 and the valve seat 23 are substantially the same as the pressure of the pressurizing chamber 2a, and these pressures are applied to the valving element 70. Accordingly, to drive the valving element 70 in the seated state and the movable holder 50 against the restoring force of the resilient member 60, there is required a driving force which is equal to or larger than a value obtained by multiplying the set pressure difference Ps between the high-pressure fuel passage 2e and the pressurizing chamber 2a by a radially inward area of the above circular contact line.

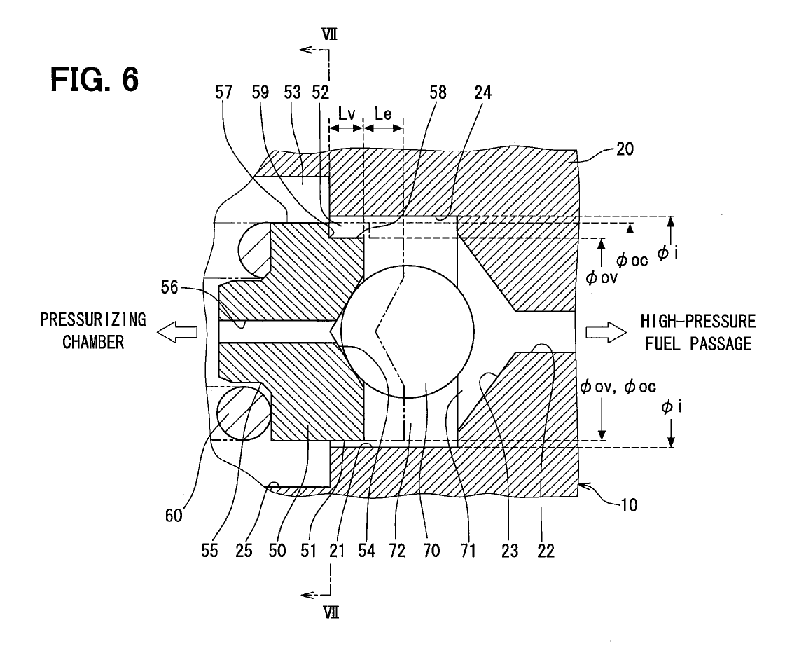

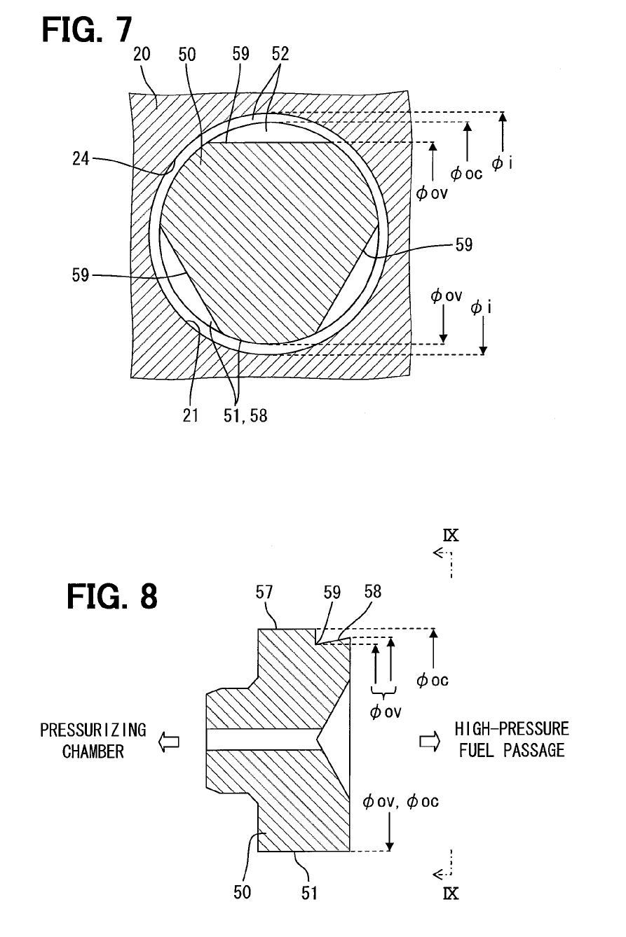

FIGS. 6 and 7 illustrate the valving element 70 in a separated state in which the element 70 is disengaged from the valve seat 23 (hereinafter referred to simply as a separated state) as a result of the pressure difference between the high-pressure fuel passage 2e and the pressurizing chamber 2a being equal to or larger than the set pressure difference Ps. In this separated state, the pressure in the pressure chamber 72 is substantially the same as the pressure in the high-pressure fuel passage 2e through a passage 71 that is annularly formed between the valving element 70 and the valve seat 23, and is applied to the valving element 70 and the movable holder 50. At the same time, in the separated state, the passage expanded hole 25, the inside of the pressure regulation hole 56, and the space portion between the valving element 70 and the holding recessed part 54 are substantially the same as the pressure of the pressurizing chamber 2a, and these pressures are applied to the valving element 70. Accordingly, the valving element 70 maintains its separated state against the restoring force of the resilient member 60 until the pressure difference between the high-pressure fuel passage 2e and the pressurizing chamber 2a becomes smaller than the set pressure difference Ps.

As illustrated in FIGS. 4 to 7, in addition to the above-described configuration, in the relief valve 10 of the first embodiment, the guide hole 24 has an inner diameter φi of an inner peripheral part 21, which is substantially constant in its circumferential direction. Also, in the relief valve 10 of the first embodiment, a constant diameter portion 57 and a diameter change portion 58 are provided for the outer peripheral portion 51 of the movable holder 50 guided by the guide hole 24.

As illustrated in FIGS. 4 to 6, the constant diameter portion 57 has an outer diameter φoc, which is substantially constant in its circumferential direction, at a portion of the outer peripheral portion 51 extending by a predetermined length from the pressurizing chamber 2a-side end portion of the portion 51. As illustrated in FIGS. 4, 6 and 7, the diameter change portion 58 adjacent to the high-pressure fuel passage 2e-side of the constant diameter portion 57 has an outer diameter φov, which changes in its circumferential direction within the outer diameter φoc of the constant diameter portion 57, at a portion of the outer peripheral portion 51 extending by a predetermined length to the high-pressure fuel passage 2e-side end of the portion 51. The diameter change portion 58 includes three or more (three in FIG. 7) notch portions 59 that are formed at regular intervals in the circumferential direction of the portion 58. Each notch portion 59 is formed in a flattened semilunar shape surrounded by a circular arc having substantially the same diameter as the outer diameter φoc and a linear chord in cross-section perpendicular to the axial direction. Accordingly, the outer diameter φov of the portion 58 at this chord is made smaller than a region of the portion 58 where the notch portion 59 is not formed.

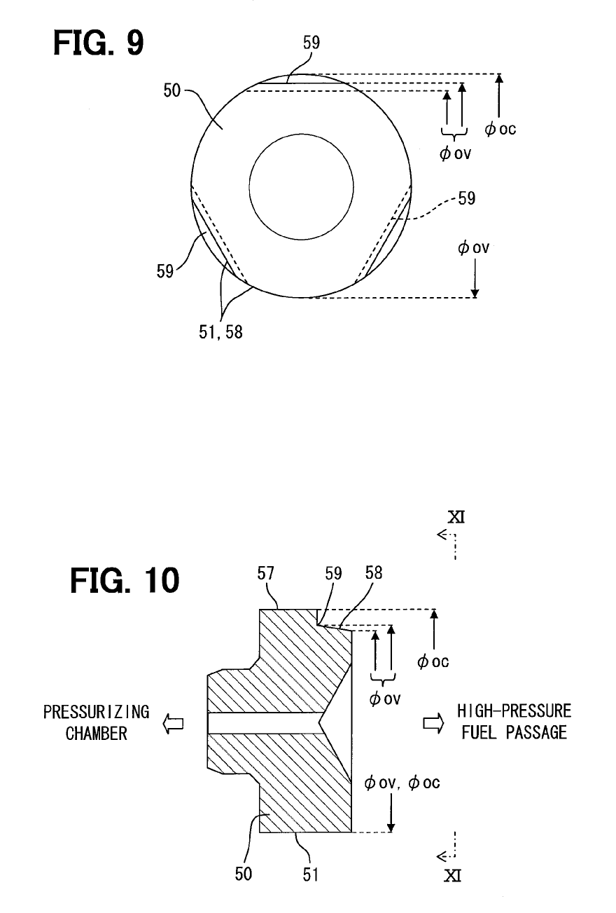

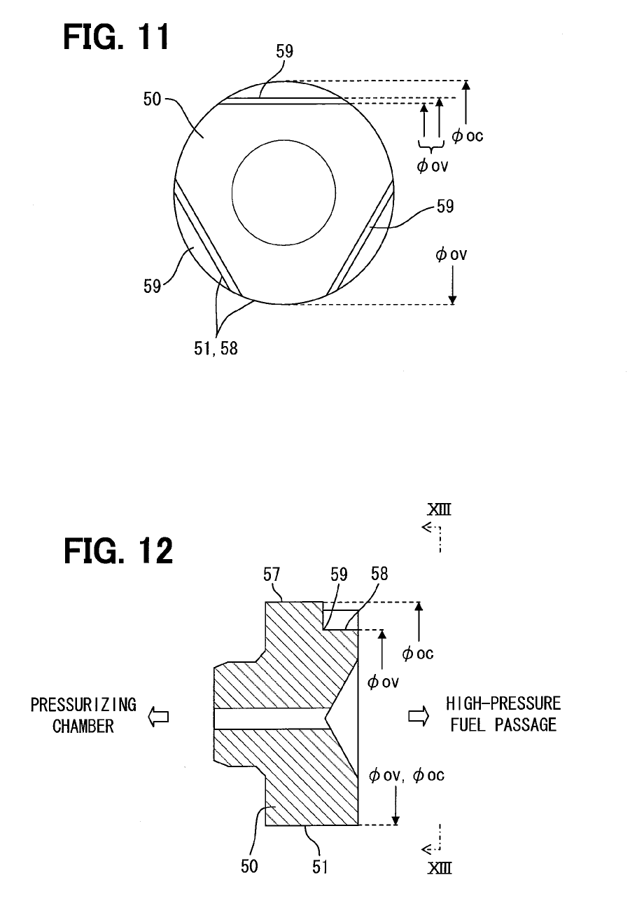

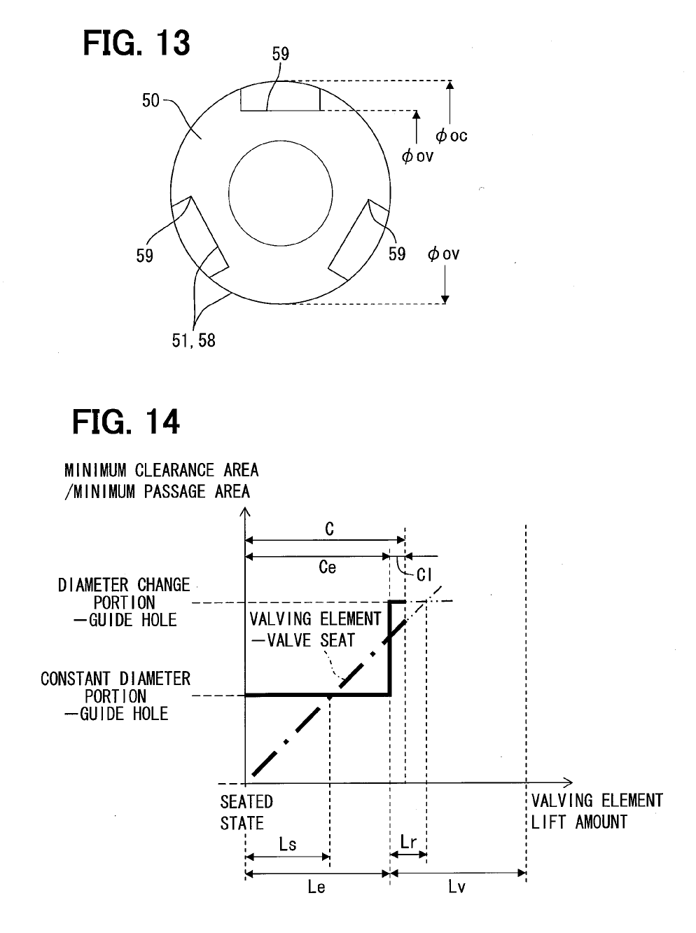

As illustrated in FIGS. 4 and 6, the inner diameter φi of the guide hole 24, the outer diameter φoc of the constant diameter portion 57, and the outer diameter φov of the diameter change portion 58 where the notch portions 59 are not formed, are substantially constant also in the axial direction. The outer diameter φov of the diameter change portion 58 where the notch portions 59 are formed, is substantially constant in the axial direction as illustrated in FIGS. 4 and 6, but may be changed in the axial direction as illustrated in FIGS. 8 to 11 for modifications. FIGS. 8 and 9 illustrate a modification in which an outer diameter φov of a diameter change portion 58 where notch portions 59 are formed, is changed to decrease in the axial direction toward a pressurizing chamber 2a. FIGS. 10 and 11 illustrate a modification in which an outer diameter φov of a diameter change portion 58 where notch portions 59 are formed, is changed to decrease in the axial direction toward a high-pressure fuel passage 2e. Furthermore, for the shape of the notch portion 59 at the diameter change portion 58, instead of the flattened semilunar shape as in FIGS. 6 and 7, a generally D-shape which is surrounded with a circular arc having substantially the same diameter as the outer diameter φoc and a rectangular recession as illustrated in FIGS. 12 and 13 as a modification, for example, may be employed.

As a result of the above configuration, the minimum clearance area in cross-section that is the smallest area of the clearance 52 formed between the movable holder 50 and the guide hole 24 as in FIGS. 4 to 7 (hereinafter referred to simply as a “minimum clearance area”) switches according to the displacement of the movable holder 50 and the valving element 70 as illustrated in FIG. 14.

Specifically, until a lift amount of the valving element 70 from the seated state (hereinafter referred to simply as a “valving element lift amount”) reaches a set distance Le, the clearance 52 (see FIG. 5) between the constant diameter portion 57 and the guide hole 24 is the minimum clearance area. As illustrated in FIG. 4, the set distance Le is an axial distance between the end of the diameter change portion 58 on the pressurizing chamber 2a-side and an end of the guide hole 24 on the pressurizing chamber 2a-side in the seated state of the valving element 70. In other words, as illustrated in FIG. 6, the set distance Le is the valving element lift amount when the entire constant diameter portion 57 is removed from the inside to outside of the guide hole 24 with the entire diameter change portion 58 accommodated in the guide hole 24.

After the lift amount reaches the set distance Le, when the valving element lift amount increases within a specific range Lr in FIG. 14 that is smaller than an axial length Lv of the diameter change portion 58, the clearance 52 (see FIG. 7) between the diameter change portion 58 and the guide hole 24 is the minimum clearance area. Thus, the minimum clearance area when the valving element lift amount is equal to or larger than the set distance Le is larger than the minimum clearance area when the valving element lift amount is smaller than the set distance Le.

Moreover, the minimum passage area in cross-section that minimizes the passage 71 between the valving element 70 and the valve seat 23 (hereinafter referred to simply as a “minimum passage area”) has a specific correlation in FIG. 14 with the minimum clearance area between the movable holder 50 and the guide hole 24 that varies as above. Specifically, until the valving element lift amount reaches a specific distance Ls which is shorter than the set distance Le, the minimum passage area between the valving element 70 and the valve seat 23 is smaller than the minimum clearance area between the constant diameter portion 57 and the guide hole 24. After the valving element lift amount becomes larger than the specific distance Ls until the lift amount reaches the set distance Le, the minimum passage area between the valving element 70 and the valve seat 23 is larger than the minimum clearance area between the constant diameter portion 57 and the guide hole 24. When the valving element lift amount increases within the specific range Lr after reaching the set distance Le, the minimum passage area between the valving element 70 and the valve seat 23 is smaller than the minimum clearance area between the diameter change portion 58 and the guide hole 24.

Operation of the relief valve 10 of the first embodiment will be described in detail.

As illustrated in FIG. 3, when the pressure difference between the high-pressure fuel passage 2e and the pressurizing chamber 2a is a normal value Pn that is smaller than the set pressure difference Ps (period A), the seated state of the valving element 70 is maintained. However, when the pressure difference between the passage 2e and the pressurizing chamber 2a becomes the set pressure difference Ps or greater as a result of the increase of pressure of the high-pressure fuel passage 2e due to abnormality (period B), the valving element 70 in the seated state is lifted together with the movable holder 50 (period C).

The valving element 70 and the movable holder 50 are lifted in the lift period C in this manner. In a lift first period Ce of this period C until the valving element lift amount reaches the set distance Le as illustrated in FIG. 14, the constant diameter portion 57 and the diameter change portion 58 slide inside the guide hole 24. For this reason, the minimum clearance area between the movable holder 50 and the guide hole 24 is produced between the constant diameter portion 57 and the guide hole 24. Particularly, until the valving element lift amount reaches the set distance Le beyond the specific distance Ls, the minimum passage area between the valving element 70 and the valve seat 23 is larger than the minimum clearance area between the constant diameter portion 57 and the guide hole 24. Accordingly, fuel flows into the passage 71 between the valving element 70 and the valve seat 23 from the high-pressure fuel passage 2e-side. A flow rate of the fuel, which has flowed into the passage 71, toward the pressurizing chamber 2a is reduced through the clearance 52 between the constant diameter portion 57 and the guide hole 24. As a result, in the lift first period Ce in FIG. 3, the pressure of the pressure chamber 72 is accumulated in a high-pressure state that is slightly lower than the high-pressure fuel passage 2e. Therefore, a pressure difference between the pressure chamber 72 and the pressurizing chamber 2a is maintained to be relatively high, so that the valving element 70 and the movable holder 50 are lifted at high speed.

In a lift second period Cl of the lift period C in FIG. 14 after the valving element lift amount has reached the set distance Le, the constant diameter portion 57 is removed to the outside of the guide hole 24, and only the diameter change portion 58 slides inside the guide hole 24. For this reason, the minimum clearance area between the movable holder 50 and the guide hole 24 is produced between the diameter change portion 58 and the guide hole 24, and is larger than in the lift first period Ce. Particularly, within the specific range Lr in which a sliding state of the diameter change portion 58 relative to the guide hole 24 is maintained, the minimum passage area between the valving element 70 and the valve seat 23 is smaller than the minimum clearance area between the diameter change portion 58 and the guide hole 24 during the increase of the valving element lift amount. Accordingly, fuel flows into the passage 71 between the valving element 70 and the valve seat 23 from the high-pressure fuel passage 2e-side. The flow rate of the fuel, which has flowed into the passage 71, toward the pressurizing chamber 2a increases due to the clearance 52 between the diameter change portion 58 and the guide hole 24. As a result, in the lift second period Cl in FIG. 3, the pressure of the high-pressure fuel passage 2e drops rapidly together with the pressure of the pressure chamber 72, so that the perssure difference between the pressure chamber 72 and the pressurizing chamber 2a also falls sharply. Because of such a rapid drop of the pressure difference, the valving element 70 and the movable holder 50 overshoot to such a degree as not to exceed the specific range Lr and then their lift is restricted. After that, the element 70 and the holder 50 return toward the high-pressure fuel passage 2e to realize the seated state of the valving element 70.

The operation and effects of the above-described first embodiment will be explained below.

In the first embodiment, the valving element 70 is lifted from its seated state toward the pressurizing chamber 2a in the lift period C; and the minimum clearance area between the movable holder 50 and the guide hole 24 is larger in the lift second period Cl of the lift period C after the valving element lift amount has reached the set distance Le than in the lift first period Ce of the lift period C until the lift amount reaches the set distance Le. Accordingly, in the lift first period Ce, the clearance 52 between the movable holder 50 and the guide hole 24 is reduced to limit a fuel flow from the high-pressure fuel passage 2e-side toward the pressurizing chamber 2a by the clearance 52. As a result, the valving element 70, to which the high pressure in the pressure chamber 72 on the passage 2e-side is applied, can be reliably lifted at high speed against the restoring force of the resilient member 60. In the lift second period Cl, the fuel flow from the high-pressure fuel passage 2e-side toward the pressurizing chamber 2a can be promoted through the clearance 52 by expanding the clearance 52. Accordingly, the lift is restricted with a sliding state of the valving element 70 maintained in the guide hole 24 to return the valving element 70, to which the restoring force of the resilient member 60 is applied, toward the passage 2e. As a result, an operation failure of the relief valve 10 can be avoided in the lift first period Ce as well as in the lift second period Cl.

In the first embodiment, until the element 70 is disengaged from the valve seat 23 to be lifted by the set distance Le beyond the specific distance Ls in the lift first period Ce, the minimum passage area between the valving element 70 and the valve seat 23 is larger than the minimum clearance area between the movable holder 50 and the guide hole 24. Accordingly, a flow of the fuel, which has flowed into the broad passage 71 between the valving element 70 and the valve seat 23, toward the pressurizing chamber 2a is limited due to the narrow clearance 52 between the movable holder 50 and the guide hole 24. As a result, high pressure is accumulated on the high-pressure fuel passage 2e-side of the movable holder 50 to achieve a high-speed lift of the valving element 70. Consequently, the effect of avoiding the operation failure of the relief valve 10 in the lift first period Ce is reliably produced.

In the first embodiment, in the lift second period Cl, the minimum passage area between the valving element 70 and the valve seat 23 is smaller than the minimum clearance area between the movable holder 50 and the guide hole 24. Accordingly, the fuel flow toward the pressurizing chamber 2a can be promoted through the clearance 52 between the movable holder 50 and the guide hole 24, which is larger than the passage 71 between the valving element 70 and the valve seat 23. As a result, the effect of avoiding the operation failure of the relief valve 10 in the lift second period Cl is reliably produced.

In the first embodiment, when the valving element lift amount toward the pressurizing chamber 2a reaches the set distance Le, the constant diameter portion 57 of the outer peripheral portion 51 of the movable holder 50 that is adjacent to its diameter change portion 58 on the high-pressure fuel passage 2e-side escapes from the inside to outside of the guide hole 24. Accordingly, in the lift first period Ce until the valving element lift amount reaches the set distance Le, the minimum clearance area can be ensured between the constant diameter portion 57 having the constant outer diameter φoc and guided in the guide hole 24, and the guide hole 24. Moreover, the diameter change portion 58 has the outer diameter φov which changes in its circumferential direction within the constant diameter portion 57. Consequently, in the lift second period Cl after the valving element lift amount has reached the set distance Le, the minimum clearance area which is larger than in the lift first period Ce can be secured between the guide hole 24 and the internal diameter change portion 58. As a result of these, the effect of avoiding the operation failure of the relief valve 10 both in the lift first period Ce and in the lift second period Cl is reliably produced.

In the first embodiment, the outer peripheral portion 51 of the movable holder 50 is guided by the guide hole 24. With regard to the high-pressure fuel passage 2e-side of this portion 51 that ensures the minimum clearance area relative to the guide hole 24 in the lift second period Cl, this minimum clearance area can be increased by the formation of the notch portion 59. Consequently, the effect of avoiding the operation failure of the relief valve 10 in the lift second period Cl is reliably produced.

In the first embodiment, between the movable holder 50 and the guide hole 24 in the lift second period Cl, the expansion amount of the minimum clearance area can be increased as far as possible by more than one notch portion 59 formed in the circumferential direction of these elements 50, 24. Accordingly, the removal of the movable holder 50 in the guide hole 24 can be reliably restricted in the lift second period Cl to produce the effect of avoiding the operation failure of the relief valve 10.

In the first embodiment, between the movable holder 50 and the guide hole 24 in the lift second period Cl, the fuel flows from the high-pressure fuel passage 2e-side toward the pressurizing chamber 2a through the inside of the notch portions 59 which are formed at regular intervals in the circumferential direction of these elements 50, 24. Accordingly, the pressure of fuel applied to the movable holder 50 inside the guide hole 24 does not easily become unbalanced in the circumferential direction. Thus, the operation failure of the relief valve 10 as a result of an inclination of the movable holder 50 due to such unbalanced pressure can be limited.

### Second Embodiment

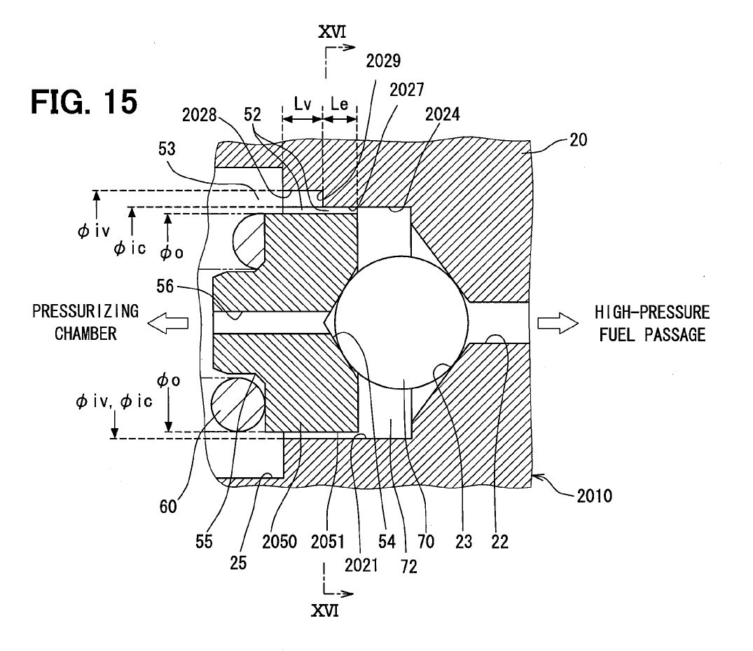

As illustrated in FIGS. 15 to 18, a second embodiment is a modification to the first embodiment. In the second embodiment, description will be given below with a focus on differences from the first embodiment.

Configuration of a relief valve will be described.

In a relief valve 2010 of the second embodiment, an outer peripheral portion 2051 of a movable holder 2050 that is guided by a guide hole 2024 with a clearance 52 defined therebetween has a constant outer diameter φo in its circumferential direction. Moreover, in the relief valve 2010 of the second embodiment, a constant diameter portion 2027 and a diameter change portion 2028 are provided for an inner peripheral part 2021 of the guide hole 2024 that guides the movable holder 2050.

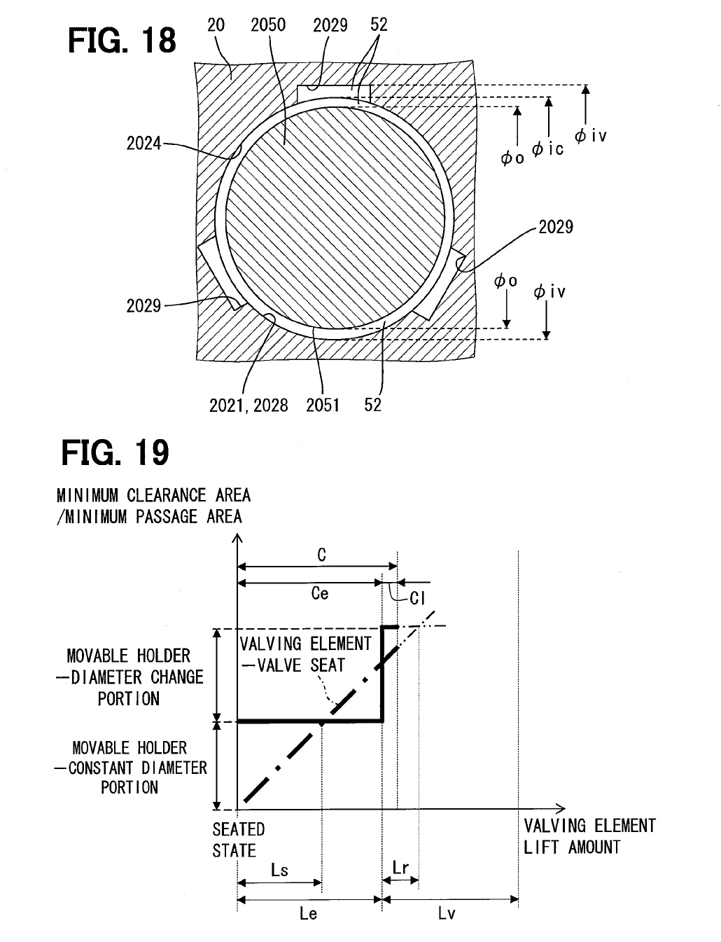

As illustrated in FIGS. 15 to 17, the constant diameter portion 2027 has an inner diameter φic which is substantially constant in the circumferential direction, at a portion of the inner peripheral part 2021 extending by a predetermined length from its end on a high-pressure fuel passage 2e-side. As illustrated in FIGS. 15, 17 and 18, the diameter change portion 2028 that is adjacent to a pressurizing chamber 2a-side of the constant diameter portion 2027 has an inner diameter φiv which changes in the circumferential direction with such a size as to be equal to or larger than the inner diameter φic of the constant diameter portion 2027, at a portion of the inner peripheral part 2021 extending by a predetermined length to its pressurizing chamber 2a-side end. The diameter change portion 2028 includes three or more (three in FIG. 18) notch portions 2029 that are formed at regular intervals in the circumferential direction of the portion 2028. Each notch portion 2029 is formed in a generally D-shape which is surrounded with a circular arc having substantially the same diameter as the inner diameter φic, and a rectangular recession in cross-section perpendicular to the axial direction. Accordingly, the inner diameter φiv at a bottom of the recession is made larger than a portion of the diameter change portion 2028 where the notch portions 2029 are not formed.

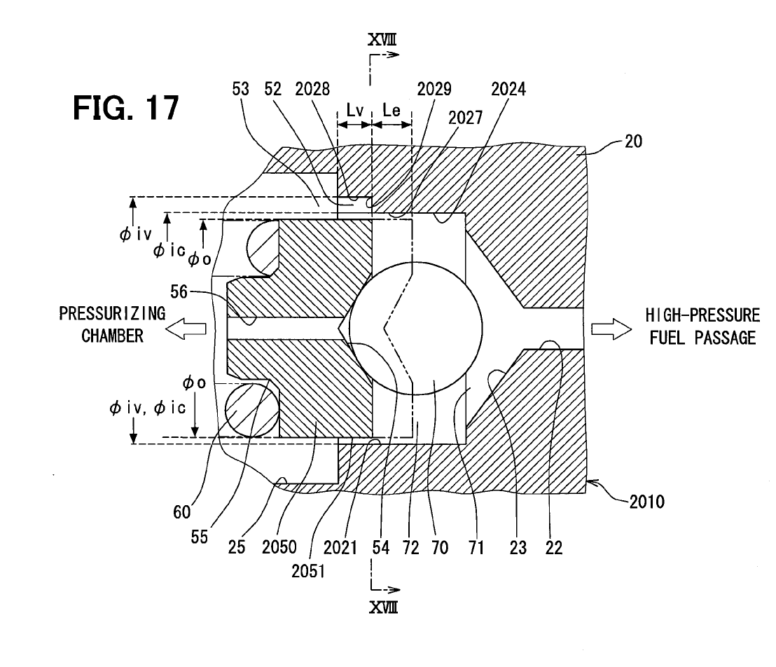

As illustrated in FIGS. 15 and 17, the outer diameter φo of the movable holder 2050, the inner diameter φic of the constant diameter portion 2027, and the inner diameter φiv of the portion of the diameter change portion 2028 where the notch portions 2029 are not formed, are substantially constant also in the axial direction. The inner diameter φiv of a portion of the diameter change portion 2028 where the notch portions 2029 are formed, is substantially constant in the axial direction as illustrated in FIGS. 15 and 17, but may be changed in the axial direction according as the outer diameter φov of the first embodiment (see FIGS. 8 to 11).

As a result of the above-described configuration, the minimum clearance area of the clearance 52 formed between the movable holder 2050 and the guide hole 2024 as in FIGS. 15 to 18 is changed according to the displacement of the movable holder 2050 and a valving element 70 similar to the first embodiment.

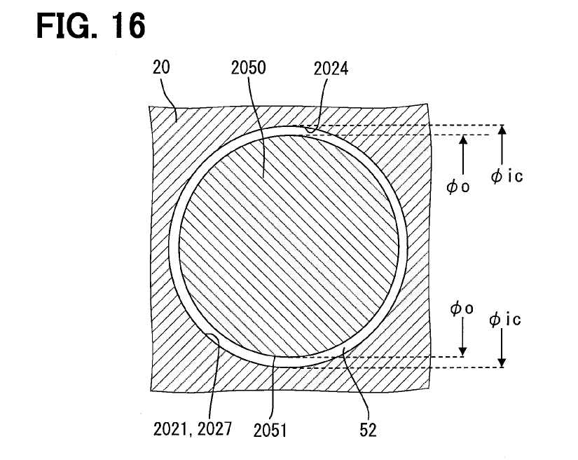

Specifically, until the valving element lift amount reaches a set distance Le, the clearance 52 (see FIG. 16) between the movable holder 2050 and the constant diameter portion 2027 is the minimum clearance area. As illustrated in FIG. 15, the set distance Le is an axial distance between the high-pressure fuel passage 2e-side end of the movable holder 2050 and the high-pressure fuel passage 2e-side end of the diameter change portion 2028 in a seated state of the valving element 70. In other words, as illustrated in FIG. 17, the set distance Le is the valving element lift amount when the movable holder 2050 escapes from the inside of the constant diameter portion 2027 toward the diameter change portion 2028.

After the lift amount has reached the set distance Le, when the valving element lift amount increases within a specific range Lr in FIG. 19 that is smaller than an axial length Lv of the diameter change portion 2028, the clearance 52 (see FIG. 18) between the movable holder 2050 and the diameter change portion 2028 is the minimum clearance area. Thus, the minimum clearance area when the valving element lift amount is equal to or larger than the set distance Le is larger than the minimum clearance area when the valving element lift amount is smaller than the set distance Le. Furthermore, the minimum passage area between the valving element 70 and a valve seat 23 has a correlation pursuant to the first embodiment as in FIG. 19 with the minimum clearance area between the movable holder 2050 and the guide hole 2024 which changes as above.

Operation of the relief valve will be described below.

In the second embodiment, the movable holder 2050 slides inside the portions 2027, 2028 of the guide hole 2024 in a lift first period Ce of a lift period C in FIG. 19. For this reason, the minimum clearance area between the movable holder 2050 and the guide hole 2024 is produced between the movable holder 2050 and the constant diameter portion 2027. Particularly, until the valving element lift amount reaches the set distance Le beyond a specific distance Ls, the minimum passage area between the valving element 70 and the valve seat 23 is larger than the minimum clearance area between the movable holder 2050 and the constant diameter portion 2027. Accordingly, fuel flows into a passage 71 between the valving element 70 and the valve seat 23 from the high-pressure fuel passage 2e-side. A flow rate of the fuel, which has flowed into the passage 71, toward the pressurizing chamber 2a is reduced through the clearance 52 between the outer peripheral portion 2051 and the guide hole 2024. As a result, in the lift first period Ce, the pressure of a pressure chamber 72 is accumulated in a high-pressure state that is slightly lower than the high-pressure fuel passage 2e. Therefore, a pressure difference between the pressure chamber 72 and the pressurizing chamber 2a is maintained to be relatively high similar to the first embodiment, so that the valving element 70 and the movable holder 2050 are lifted at high speed.

In the second embodiment, in a lift second period Cl of the lift period C shown in FIG. 19, the movable holder 2050 is removed from the inside of the constant diameter portion 2027 toward the diameter change portion 2028 and slides only inside the diameter change portion 2028. For this reason, the minimum clearance area between the movable holder 2050 and the guide hole 2024 is produced between the movable holder 2050 and the diameter change portion 2028, and is larger than in the lift first period Ce. Particularly, within the specific range Lr in which a sliding state of the movable holder 2050 relative to the diameter change portion 2028 is maintained, the minimum passage area between the valving element 70 and the valve seat 23 is smaller than the minimum clearance area between the movable holder 2050 and the diameter change portion 2028 during the increase of the valving element lift amount. Accordingly, fuel flows into the passage 71 between the valving element 70 and the valve seat 23 from the high-pressure fuel passage 2e-side. The flow rate of the fuel, which has flowed into the passage 71, toward the pressurizing chamber 2a increases due to the clearance 52 between the movable holder 2050 and the diameter change portion 2028. As a result, in the lift second period Cl, the pressure of the high-pressure fuel passage 2e drops rapidly together with the pressure of the pressure chamber 72, so that the pressure difference between the pressure chamber 72 and the pressurizing chamber 2a also falls sharply similar to the first embodiment. Because of such a rapid drop of the pressure difference, the valving element 70 and the movable holder 2050 overshoot to such a degree as not to exceed the specific range Lr and then their lift is restricted. After that, the element 70 and the holder 2050 return toward the high-pressure fuel passage 2e to realize the seated state of the valving element 70.

As a result of the above second embodiment, operation and its effects according as the first embodiment can be produced. Particularly, in the second embodiment, when the valving element lift amount toward the pressurizing chamber 2a reaches the set distance Le, the movable holder 2050 escapes from the inside of the constant diameter portion 2027 of the inner peripheral part 2021 of the guide hole 2024, which is adjacent to the diameter change portion 2028 on the pressurizing chamber 2a-side, toward the diameter change portion 2028. Accordingly, in the lift first period Ce until the valving element lift amount reaches the set distance Le, the minimum clearance area can be secured between the movable holder 2050 which is guided inside the constant diameter portion 2027 having the constant inner diameter φic, and the constant diameter portion 2027. Moreover, the diameter change portion 2028 has the inner diameter φiv which changes in its circumferential direction with such a size as to be equal to or larger than the constant diameter portion 2027. Consequently, in the lift second period Cl after the valving element lift amount has reached the set distance Le, the minimum clearance area which is larger than in the lift first period Ce can be secured between the diameter change portion 2028 and the internal movable holder 2050. As a result of these, the effect of avoiding the operation failure of the relief valve both in the lift first period Ce and in the lift second period Cl is reliably produced.

In the second embodiment, the inner peripheral part 2021 of the guide hole 2024 guides the movable holder 2050; and the minimum clearance area can be increased as a result of the formation of the notch portions 2029 on the pressurizing chamber 2a-side of the inner peripheral part 2021 which secures the minimum clearance area relative to the movable holder 2050 in the lift second period Cl. Consequently, the effect of avoiding the operation failure of the relief valve 2010 in the lift second period Cl is reliably produced.

Modifications of the above embodiments will be described.

The embodiments have been described above. The present disclosure is not interpreted by limiting to these embodiments, and can be applied to various embodiments and their combination without departing from the scope of the disclosure.

Specifically, as regards the notch portions 59, 2029 which define the diameter change portion 58, 2028, in a first modification, three or more notch portions 59, 2029 may be formed at irregular intervals in the circumferential direction. Alternatively, in a second modification, one or two notch portion(s) 59, 2029 may be formed at (a) predetermined position(s) in the circumferential direction. As for the diameter change portion 58, 2028, in a third modification, a configuration in which the outer diameter φov or the inner diameter φiv changes may be employed through formation of a projection that projects in the radial direction. In a fourth modification, the outer diameter φov or the inner diameter (ply of a portion of the diameter change portion 58, 2028 where the notch portions 59, 2029 are not formed, may be changed in the axial direction. In a fifth modification, a magnitude relationship of the minimum passage area between the valving element 70 and the valve seat 23; and the minimum clearance area between the movable holder 50, 2050 and the guide hole 24, 2024, may be set suitably respectively in the lift first period Ce and in the lift second period Cl.

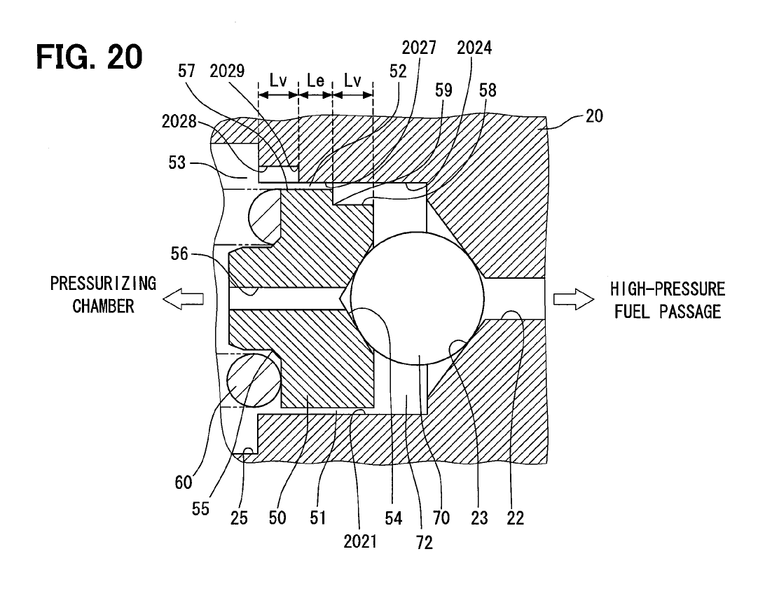

In a sixth modification illustrated in FIG. 20, the movable holder 50 of the first embodiment, and the guide hole 2024 of the second embodiment may be combined together. In this sixth modification, an axial distance between an end of the diameter change portion 58 on the pressurizing chamber 2a-side, and an end of the diameter change portion 2028 on the high-pressure fuel passage 2e-side is the set distance Le. In a seventh modification, a shape other than a full-spherical shape, for example, a hemispherical shape may be employed for the shape of the valving element 70. In an eighth modification, a shape other than a cylindrical hole shape, for example, a rectangular cylindrical hole shape, may be used for the shape of the guide hole 24, 2024; and accordingly a shape other than a cylindrical shape, for example, a rectangular columnar shape, may also be used for the shape of the movable holder 50, 2050. In a ninth modification, various kinds of springs other than a compression coil spring, or members made of rubber, for example, may be employed for the resilient member 60.

To sum up, the relief valve 10, 2010 of the above embodiments can be described as follows.

A relief valve 10, 2010 is adapted for a high-pressure fuel pump 2 that includes a pressurizing chamber 2a and a high-pressure fuel passage 2e and that pressurizes fuel drawn into the pressurizing chamber 2a to discharge fuel into the high-pressure fuel passage 2e. The relief valve 10, 2010 is disposed between the pressurizing chamber 2a and the high-pressure fuel passage 2e and is configured to release pressure in the high-pressure fuel passage 2e into the pressurizing chamber 2a when the pressure in the high-pressure fuel passage 2e becomes higher than pressure in the pressurizing chamber 2a by a set pressure difference Ps or larger. The relief valve 10, 2010 includes a valving element 70, a movable holder 50, 2050, a housing 20, and a resilient member 60. The valving element 70 is reciprocatable between the pressurizing chamber 2a and the high-pressure fuel passage 2e. The movable holder 50, 2050 is disposed on the pressurizing chamber 2a-side of the valving element 70 and holds the valving element 70. The movable holder 50, 2050 is movable integrally with the valving element 70. The housing 20 includes a guide hole 24, 2024 and a valve seat 23. The guide hole 24, 2024 accommodates the movable holder 50, 2050 therein and guides the movable holder 50, 2050 toward the pressurizing chamber 2a or toward the high-pressure fuel passage 2e. The valving element 70 is engaged or disengaged respectively with or from the valve seat 23 on the high-pressure fuel passage 2e-side. The resilient member 60 is configured to generate restoring force to urge the movable holder 50, 2050 toward the high-pressure fuel passage 2e. The valving element 70 is lifted from its seated state, in which the valving element 70 is engaged with the valve seat 23, toward the pressurizing chamber 2a in a lift period C. The lift period C includes a lift first period Ce and a lift second period Cl. An amount of the lift of the valving element 70 reaches a set distance Le in the lift first period Ce. The lift second period Cl is after the amount of the lift of the valving element 70 has reached the set distance Le. The movable holder 50, 2050 slides inside the guide hole 24, 2024 both in the lift first period Ce and in the lift second period Cl. A minimum clearance area between the movable holder 50, 2050 and the guide hole 24, 2024 is larger in the lift second period Cl than in the lift first period Ce.

The valving element 70 is lifted from its seated state on the valve seat 23 toward the pressurizing chamber 2a in the lift period C. The minimum clearance area between the movable holder 50, 2050 and the guide hole 24, 2024 is larger in the lift second period Cl of the lift period C that is after the lift amount has reached the set distance Le than in the lift first period Ce of the lift period C that is until the lift amount reaches the set distance Le. Accordingly, in the lift first period Ce, the clearance between the movable holder 50, 2050 and the guide hole 24, 2024 is reduced to limit a fuel flow from the high-pressure fuel passage 2e-side toward the pressurizing chamber 2a by this clearance. As a result, the valving element 70, to which the high pressure on the high-pressure fuel passage 2e-side is applied, can be reliably lifted at high speed against the restoring force of the resilient member 60. In the lift second period Cl, the clearance between the movable holder 50, 2050 and the guide hole 24, 2024 is broadened to promote the fuel flow from the high-pressure fuel passage 2e-side toward the pressurizing chamber 2a by this clearance. Consequently, the lift is restricted with a sliding state of the valving element 70 maintained in the guide hole 24, 2024 to return the valving element 70, to which the restoring force of the resilient member 60 is applied, toward the high-pressure fuel passage 2e. As a result, the operation failure of the relief valve can be avoided in the lift first period Ce as well as in the lift second period Cl.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A relief valve adapted for a high-pressure fuel pump that includes a pressurizing chamber and a high-pressure fuel passage and that pressurizes fuel drawn into the pressurizing chamber to discharge fuel into the high-pressure fuel passage, the relief valve disposed between the pressurizing chamber and the high-pressure fuel passage and configured to release pressure in the high-pressure fuel passage into the pressurizing chamber when the pressure in the high-pressure fuel passage becomes higher than pressure in the pressurizing chamber by a set pressure difference or larger, the relief valve comprising:
a valving element that is reciprocatable between the pressurizing chamber and the high-pressure fuel passage;
a movable holder that is disposed on the pressurizing chamber-side of the valving element and holds the valving element wherein the movable holder is movable integrally with the valving element;
a housing that includes:
a guide hole that accommodates the movable holder therein and guides the movable holder toward the pressurizing chamber or toward the high-pressure fuel passage; and
a valve seat with or from which the valving element is engaged or disengaged respectively on the high-pressure fuel passage-side; and
a resilient member that is configured to generate restoring force to urge the movable holder toward the high-pressure fuel passage, wherein:
the valving element is lifted from its seated state, in which the valving element is engaged with the valve seat, toward the pressurizing chamber in a lift period including:
a lift first period in which an amount of the lift of the valving element reaches a set distance; and
a lift second period, which is after the amount of the lift of the valving element has reached the set distance;
the movable holder slides inside the guide hole both in the lift first period and in the lift second period; and
a minimum clearance area between the movable holder and the guide hole is larger in the lift second period than in the lift first period.

2. The relief valve according to claim 1, wherein a minimum passage area between the valving element and the valve seat is larger than the minimum clearance area between the movable holder and the guide hole until the valving element is lifted by the set distance beyond a specific distance in the lift first period.

3. The relief valve according to claim 1, wherein a minimum passage area between the valving element and the valve seat is smaller than the minimum clearance area between the movable holder and the guide hole in the lift second period.

4. The relief valve according to claim 1, wherein:
an outer peripheral portion of the movable holder that is guided by the guide hole includes:
a constant diameter portion whose outer diameter is constant in its circumferential direction; and
a diameter change portion which is adjacent to the high-pressure fuel passage-side of the constant diameter portion and whose outer diameter changes in its circumferential direction with such a size as to be equal to or smaller than the constant diameter portion; and
when the amount of the lift of the valving element reaches the set distance, the constant diameter portion is removed from inside to outside of the guide hole.

5. The relief valve according to claim 1, wherein:
an outer peripheral portion of the movable holder is guided by the guide hole; and
the high-pressure fuel passage-side of the outer peripheral portion that ensures the minimum clearance area relative to the guide hole in the lift second period includes a notch portion.

6. The relief valve according to claim 5, wherein the notch portion is one of a plurality of notch portions that are formed in a circumferential direction of the outer peripheral portion.

7. The relief valve according to claim 6, wherein the plurality of notch portions are formed at regular intervals in the circumferential direction.

8. The relief valve according to claim 1, wherein:
an inner peripheral part of the guide hole that guides the movable holder includes:
a constant diameter portion whose inner diameter is constant in its circumferential direction; and
a diameter change portion which is adjacent to the pressurizing chamber-side of the constant diameter portion and whose inner diameter changes in its circumferential direction with such a size as to be equal to or larger than the constant diameter portion; and
when the amount of the lift of the valving element reaches the set distance, the movable holder is removed from inside of the constant diameter portion toward the diameter change portion.

9. The relief valve according to claim 1, wherein:
an inner peripheral part of the guide hole guides the movable holder; and
the pressurizing chamber-side of the inner peripheral part that secures the minimum clearance area relative to the movable holder in the lift second period includes a notch portion.

10. The relief valve according to claim 9, wherein the notch portion is one of a plurality of notch portions that are formed in a circumferential direction of the inner peripheral part.

11. The relief valve according to claim 10, wherein the plurality of notch portions are formed at regular intervals in the circumferential direction.

12. A fuel supply system comprising:
the high-pressure fuel pump that includes the relief valve recited in claim 1; and
a fuel injection system that is configured to inject fuel, which is supplied through the high-pressure fuel passage of the high-pressure fuel pump, into an internal combustion engine.
